(19) United States
(12) Patent Application Publication
(10) Pub. No.: US 2025/0190370 A1
(43) Pub. Date: Jun. 12, 2025

(54) REDUCED LATENCY LOW-POWER STATE EXIT

(71) Applicant: Intel Corporation, Santa Clara, CA (US)

(72) Inventors: Sivakumar B, Bangalore (IN); Binoy BALAN, Bangalore (IN); Atul Pratap Singh CHAUHAN, Bangalore (IN)

(21) Appl. No.: 18/537,063

(22) Filed: Dec. 12, 2023

(51) Int. Cl. G06F 12/14; G06F 1/3296; G06F 21/57

(52) U.S. Cl. CPC G06F 12/1408; G06F 1/3296; G06F 21/575; G06F 2212/1052; G06F 2221/034

(57) ABSTRACT

In some embodiments, low-power states, where exit code is stored in a vulnerable memory and should be crypto verified, may be enhanced by verifying the code before entering the low-power state and storing it in a write-lockable memory so that it may be executed when coming out of the low-power state without having to crypto verify it.

### TECHNICAL FIELD

Embodiments of the invention relate to the field of processors, and more specifically, to techniques for exiting a low-power state.

### BRIEF DESCRIPTION OF THE DRAWINGS

The disclosure may best be understood by referring to the following description and accompanying drawings that are used to illustrate embodiments of the invention. In the drawings:

FIG. 1 is a block diagram of a generic processor with a root of trust (RoT) HW circuit.

FIG. 2 is a block diagram of a processor with RoT HW in accordance with some embodiments.

FIG. 3 is a block diagram of a system management block in accordance with some embodiments.

FIG. 4 is a block diagram of a write lockable RWM in accordance with some embodiments.

FIG. 5 is a flow diagram of a routine for managing code execution in a boot block in accordance with some embodiments.

FIG. 6 is a block diagram showing a computing system having multiple processors with low-power state exit techniques in accordance with some embodiments.

FIG. 7 illustrates an example computing system in accordance with some embodiments.

FIG. 8 illustrates a block diagram of an example processor for use in the system of FIG. 7 in accordance with some embodiments.

### DETAILED DESCRIPTION

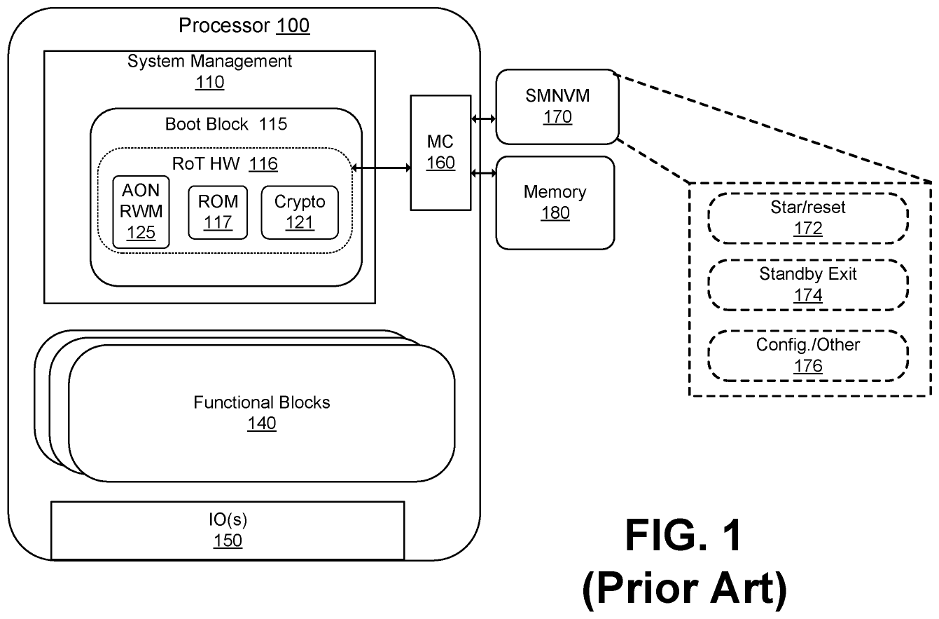

FIG. 1 is a block diagram of a generic processing device (also referred to herein as processor) 100 with a root of trust (RoT) circuit for implementing secure reset and standby exit operations. The processor 100 generally includes a System Management section 110, functional blocks 140, input/output (I/O) link interface blocks 150, and a memory controller block 160 including circuitry for controlling SMNVM (system management non-volatile memory) 170 and memory 180 such as volatile dynamic random access memory (DRAM).

The functional blocks 140 correspond to the various blocks in a processing system. The IO blocks 160 comprise one or more IO link interfaces to communicatively link the processor with other entities. The SMNVM 170 stores system execution management code and configuration data such as start-up/reset code 172, standby exit code 174, and configuration settings and data 176.

The system management section 110 includes a boot block 115 for controlling processor boot operations (start-up, reset), as well as secure exits from low-power states such as from standby states. The boot block 115 includes secure root-of-trust (RoT) hardware (HW) circuitry 116 to facilitate secure boot and reset operations. The ROT HW (also referred to as RoT circuitry) includes read-only memory (ROM) 117, a cryptographical (crypto) verification circuitry (also referred to as crypto engine) 121, and always-on (AON) read/writeable memory (RWM) 125. It also includes micro-controller and/or state machine circuits (not expressly depicted) to implement and oversee various system execution flows on behalf of the system management block 110.

In operation, when the processor is powered on or reset in some cases, the boot block begins by executing start (or boot) code from ROM 117, which causes appropriate start/reset code 172 from the SMNVM 170 to be retrieved and crypto verified through crypto engine (circuit) 121. Once the code is verified, it is executed, configuring various processor system components and loading for execution both trusted and untrusted OS (operating system) kernel portions before ultimately handing off system execution flow control to the OS.

When the processor goes to a standby state, it stores some context state information (e.g., critical context/config. data) in the AON RWM 125 but “dumps” most of the overall context state and config. information into the memory 180 and then powers down most of the processor blocks to save power. Unfortunately, Since the system is typically connected to other devices through the IO blocks 150, the PHY subsystems of the IO blocks and parts of their controllers need to at least remain partially powered. For example, they are typically kept in a suitable low power state corresponding to the particular processor device type and/or utilized link type. For example, during a standby state, PCIe (Peripheral Chip Interconnect) links may be in an L2 or L1.2 state, and if the processor 100 is configured as an ACPI (Advanced Configuration and Power Interface) compliant device with other linked devices and/or with a host, it may be in a D3 state. In addition, various device fabric infrastructures should be in an ungated state to receive and process packets from a link should any arrive. So, these blocks may unavoidably consume much of a processor device's standby power budget, resulting in little power being available for other device components or sub-systems during the low-power state.

Accordingly, it would be desirable to be able to at least partially power gate RoT HW during a standby state. However, if this is done, when coming back from the standby state, the ROT must securely be re-activated. Among other things, this means that the standby exit code 174 cannot simply be retrieved and executed, but rather, it must first be crypto verified, e.g., through crypto engine 121. This is problematic because it can impose a substantial latency penalty. On the other hand, if the RoT is kept powered, e.g., with its controller/FSM context states and data intact, exit latencies can be dramatically reduced because execution ROT context need not be reestablished from crypto-verified SM NVM code, but necessary standby power savings from power gating the RoT HW may be lost. Accordingly, solutions addressing both power and latency would be desired.

In some embodiments, a system execution management chain of trust may be established when exiting a reduced, or low power, state such as a standby state without having to employ cryptographic verification, one of the primary contributors for exit latencies, yet maintains security robustness. For example, low-power state exit code (e.g., standby exit code) may be cryptographically verified during a reset and stored in AON RWM (e.g., RAM). In some embodiments, hardware-enabled hardening may be employed to write lock the RWM to ensure that the code is authentic (not compromised).

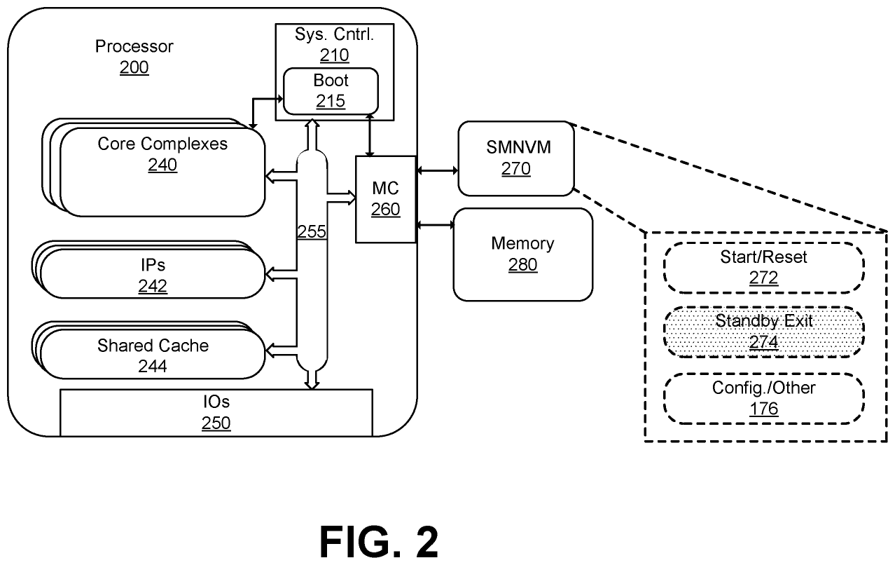

FIG. 2 is a block diagram of a processing device (processor) with a low-power state ROT feature in accordance with some embodiments. The processor 200 could be any processing device such as a CPU, a discrete graphics processing unit (DGPU), an artificial intelligence (AI) accelerator, and the like implemented in any suitable manner such as in a system-on-package (SoP), multi-chip package (MCP), or on a card or circuit board, and the like. The processor 200 generally includes a System Management section 210, core complexes 240, IP blocks 242, shared cache 244, (IO) link interface blocks 250, and a memory controller 260, inter-connected to one another by way of system interconnect fabric 255. The memory controller includes circuitry for controlling SMNVM (system management non-volatile memory) 270 and memory 280.

The core complexes 240 correspond to the various core types (e.g., CPU, graphics, vector-enhanced, low-power, AI) that may be used in a processing system. The IP (intellectual property) blocks 242 correspond to functional circuits such as IPUs (image processing units), VPUs (video processing units), DSPs (digital signal processors), DEs (display engines), etc. The IO blocks 160 comprise one or more IO link interfaces such as PCIe (peripheral chip interconnect), CXL (Compute Express Link), USB (Universal Serial Bus), etc. to communicatively link the processor with other entities such as other processors, networks, peripheral devices, and the like. The SMNVM 170, sometimes referred to as Flash (e.g., BIOS flash, uEFI flash, VBIOS flash, etc.) stores system execution management code and configuration data such as start-up/reset code 172, standby exit code 174, and configuration settings and data 176, as is indicated, for booting a processor or for coming out of a low-power state or reset.

The system management section 210 includes a boot block 215 for, among other things, controlling processor boot operations (start-up, reset), as well as secure exits from low-power states such as from a standby state. It may also include various other system management blocks (not shown) such as power/performance control and internal bus management blocks.

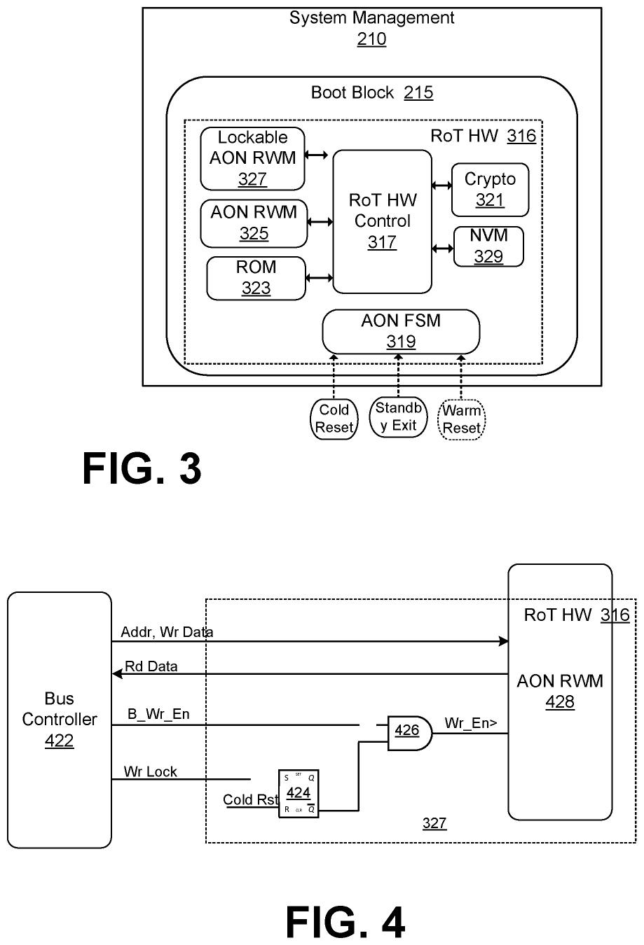

FIG. 3 is a block diagram of a system management block 210 in accordance with some embodiments. System management block 210 includes boot block 215, which in turn, comprises secure root-of-trust (RoT) hardware (HW) circuitry 316 for facilitating secure boot, restart, and some low-power state (e.g., standby) exit operations.

A hardware ROT (ROT HW or ROT circuitry) is typically the foundation on which secure operations of a processing system depend. It is inherently trusted, and therefore is designed with features (hardened circuitry, security hooks, etc.) to make it secure by design. In general, it may be a fixed function RoT HW, a programmable RoT HW, or combinations of both fixed function and programmable ROT circuitry. Fixed function ROT blocks are typically compact and designed to perform a specific set of functions like data encryption, certificate validation or key management. In contrast, hardware-based programmable root of trust blocks, as well as being configurable, are also typically more robust, performing many functions of a fixed RoT, along with the ability to execute a more complex set of security functions. For example, a programmable ROT HW may be upgradable, enabling it to run new cryptographic algorithms and secure applications to meet evolving attack vectors. In fact, a programmable RoT may include one or more fixed function RoTs, along with other security management functionality.

The depicted Boot/ROT HW includes an RoT HW control circuit 317 (e.g., one or more micro-controllers and/or state machines), always on (AON) FSM (finite state machine) 319, cryptographic (e.g., asymmetric signed crypto) engine 321, read-only memory (ROM) 323, AON RWM (read write memory) 325, and a write-lockable always-on (AON) RWM 328. As used herein, RWM may be any suitable read and writeable memory such as SRAM (static random access memory) and the like.

The RoT HW control circuitry facilitate secure data flows and implements and overseas code execution until hand-off to an OS kernel. The crypto circuit 321, which may be a hardened application specific crypto circuit or implemented with a micro-controller running immutable firmware, performs crypto authentication on boot, reset or low-power state exit execution code that may not be secure, e.g., restart or standby exit code stored in SM NVM. The AON FSM 319 remains on during low-power states and initiates activation of the Boot ROT HW when started, re-started or awoken. In some embodiments, it may also include non-volatile memory (NVM) 329 for more secure updateable ROT functionality. In such cases the firmware should be authenticated and loaded during cold boot and stored in internal RAM that can't be tampered.

Also shown are signal inputs for initiating a wake event from a low-power state such as a standby state or from another circumstance such as an off or frozen processing system. They include a standby exit signal, along with cold and warm reset signals. While shown as individual signal lines, they may share one or more lines, interrupts, or even be conveyed over a bus or other shared inter-connect link.

(Note that in this figure, the ROT HW is enclosed with a dashed box within the boot block. This is to represent that the RoT HW may actually include more or less circuit components, likely located within a boot block, although this is not required. An RoT HW may have functionality other than boot, reset and exit facilitation, as discussed herein. For case of presentation, the boot block and RoT HW are used somewhat interchangeably since with respect to innovative features in this disclosure, they overlap to a large extent.)

FIG. 4 is a block diagram of a write lockable RWM in accordance with some embodiments. The depicted write lockable RWM circuit includes an S/R latch or flop 424, an AND gate 426, and an RWM such as block of RAM 428, coupled together as shown. Also shown is a bus controller 422, which may be part of a system management block or another processor block, and controls the write lockable RWM 428 and to write data into and read data out from it.

With the AND gate having one of its inputs coupled to a cold reset indication signal, which asserts when a cold reset (e.g., power-on or re-boot) occurs, it can assert the write enable (wr_en) signal to enable a write operation to the RWM 428 if the cold reset has “reset” the latch 424. Anytime thereafter, if/when the Write Lock signal asserts, it causes the latch to set, which disables the AND gate, and thus the RWM, until a cold reset occurs once again. In operation, this will allow for the boot block to write verified standby exit code into the RWM upon a cold reset event and be assured that the code will not be altered until a next cold restart event, i.e., writes are locked after the initial code is loaded.

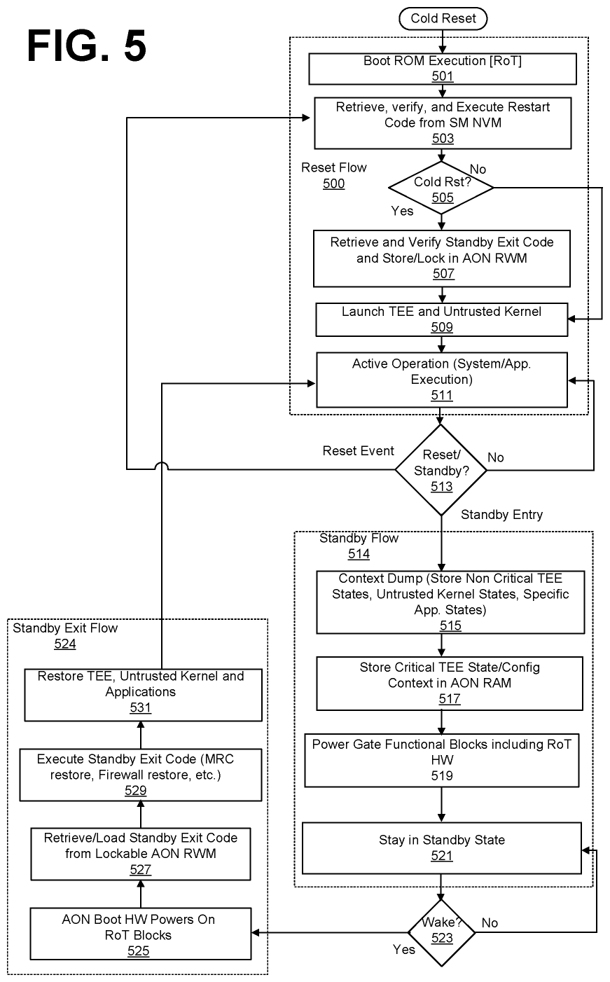

FIG. 5 is a flow diagram of a routine for managing code execution in a boot block in accordance with some embodiments. For example, this flow may be implemented by a boot block 210, in cooperation with RoT HW included therein, in a processor 200. The routine generally includes three separate flow sections: a reset flow section 500, a standby flow section 514, and a standby exit flow section 524. The reset flow section includes operations for execution flow control in response to either a reset (boot from start-up or reset) or standby state exit event. In turn, the standby entry flow section 514 includes operations for when a standby state is to be entered, while the standby exit flow 524 includes operations for when the standby state is to be exited. (It should be appreciated that while a standby state is used as an exemplary low-power state for applying the ROT techniques described herein, embodiments are not so limited. Standby is a deep powered down state where restart code, e.g., standby exit code, is used to restore a chain of trust code execution management framework but there are other low-power states where this may also be of value. In addition, depending on the utilized operating system, different standby flavors including a modern standby, sleep, hibernation, or other low-power states may be exited as taught herein. Moreover, embodiments include but are not limited to situations where code used to build code execution management framework in a chain of trust is stored in an unsecure memory and should be crypto verified prior to being executed. This may be the case in a processor for situations other than start-up, reset or coming out of a low-power state such as a standby state.)

The reset flow 500 begins at 501 in response to a cold reset event such as when a processor is powered on or restarted after crashing or freezing. At 501, the boot block fetches and executes boot code from the ROM 323. This begins the process of establishing a root, or chain, of trust framework within the processor system management infra-structure. (This is not to be confused with the RoT HW, which is part of the circuitry to create and maintain a root (or chain) of trust framework.) Next, at 503, the boot block/ROT HW retrieves restart (or boot) code from the SM NVM and verifies its authenticity through the crypto circuit 321. (Note that the flow could be at this stage 503 from a standby exit as well as from a restart.) Once verified, it loads and begins execution of the verified code. At 505, it checks to determine if it is in a restart or a standby exit flow. If the latter, it jumps to 509, but if it is in a restart flow, it proceeds to 507 where it retrieves standby exit code that is stored in the SM NVM 270. It verifies the code in the crypto circuit 321 and if authentic (not corrupted), it then stores the verified code in the lockable RWM 327 and then locks the RWM.

At 509, the executing restart code sets up a TEE (trusted execution environment) and launches the OS kernel including untrusted, as well as trusted-environment, kernel portions and hands off execution control thereto. At 511, the kernel and any activated applications execute in normal operational modes. At 513, the kernel, which is now in execution flow control, in essence, confirms that neither a standby (or other power reduction state) event or a restart event is not to occur. If not, the routine stays at 511, with the OS and launched applications executing normally. On the other hand, if a restart or standby event is to occur, control is handed back to the system management block, and the routine either returns to 503 (if restart event) or proceeds to the standby flow section 514 if a standby event is to occur.

If a standby event is to occur, then at 515, the routine “dumps” non-critical context state information such as non-critical TEE states, untrusted kernel states and certain app context data into memory 280 or other larger volume but less secured memory, e.g., solid-state NVM, e.g., for extreme power savings states where DRAM self-refresh may be avoided. At 517, in contrast, it stores critical TEE context states and other critical configuration data into AON RWM 525. This memory is smaller in volume, as compared with memory 280, so critical context state information is allotted to internal AON memory, which is more secure with faster accessibility as compared with external memory. At 519, most of the processor's functional blocks, including much if not most of the RoT HW, apart from the AON FSM 319 and lockable AON RWM 327, is then powered down. At 521, the routine essentially stays in the standby state until at 523, a standby exit event is detected, which causes the routine to proceed to the standby exit flow section 524.

Upon initiation of standby exit, the routine goes to 525 where the AON FSM 319 portion(s) of the RoT HW 316 activates the rest of the ROT HW used for system execution management re-activation. At 527, it retrieves and loads the already verified standby exit code from the lockable RWM 327. Note that this is much faster than if it had to verify the exit code through the crypto circuitry 321.

In some embodiments, since crypto verification is not performed on the retrieved exit code, there can be concerns about attacks happening on the standby exit code by means of physical attacks like voltage and clock glitching thereby corrupting the standby exit code, which could go undetected. To mitigate against such attacks, a hash signature for the standby exit code could be stored in an RoT HW register (not shown). The code could then be verified during standby exit by the RoT HW. Hash verification would likely take less time than crypto verification, e.g., almost 10× less than if a crypto sign verification process were used, thereby justifying a trade-off between exit latency and enhanced security.

Returning back to the flow diagram, at 529, the standby exit code is executed. Among other things, this causes the MRC (memory reference code) and firewall to be restored. With MRC restoration, external, as well as internal AON RWM, can be accessed. At 531, the routine retrieves context state information from the AON RWM 525 and from external memory (e.g., 280) and re-establishes the TEE, once again launching both trusted and untrusted kernel portions for hand-off thereto. It also initiates launch of applications that were suspended, putting them back into their pre-standby contexts. From here, the routine returns to 511 and proceeds as described.

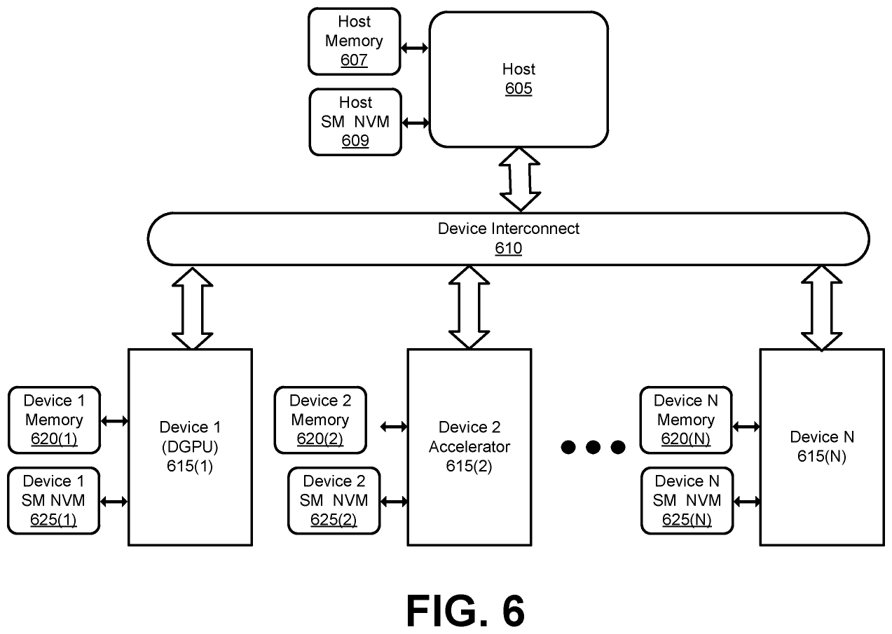

FIG. 6 is a block diagram showing a computing system having multiple processors with low-power state exit/entry techniques in accordance with some embodiments as discussed above. The system generally includes a host compute system 605 coupled to multiple devices 615 (1-N) through device interconnect 610. The host has associated memory 607 and SM NVM 609, as shown, and it may be implemented with any suitable compute system such as a CPU (central processing unit), APU (application processing unit), SoC (system on Chip/package), or the like and may be implemented in accordance with a processor as discussed above. The device interconnect 610 may include one or more different interconnect links and/or fabrics such as PCIe, CXL or other link/network protocols.

Each device 615 has an associated device memory 620 (i) and an associated device SM NVM 625 (i). The memories and SM NVMs will correspond to the type of device being implemented. For example, device 1 is a DGPU, which may use so-called VBIOS (video basic input/output system) flash to implement its SM NVM. Along these lines, each device runs an appropriate OS kernel, e.g., a micro-kernel or any other suitable operating system for the device.

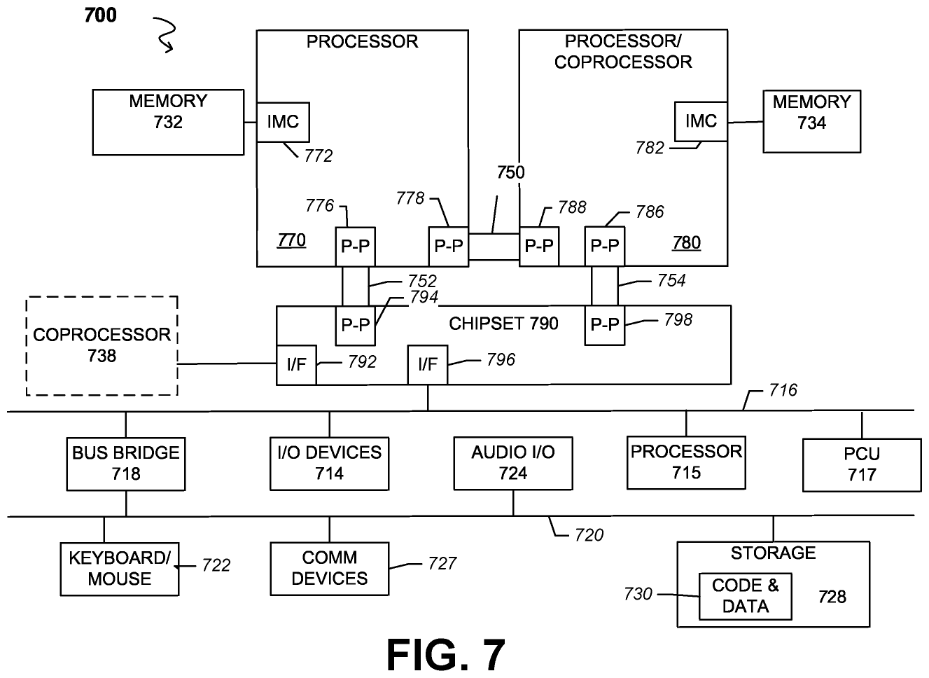

FIG. 7 illustrates an example computing system. Multiprocessor system 700 is an interfaced system and includes a plurality of processors including a first processor 770 and a second processor 780 coupled via an interface 750 such as a point-to-point (P-P) interconnect, a fabric, and/or bus. Either or both processors 770 and 780 may include boot block and/or root-of-trust hardware embodiments described herein. In addition, either or both processors could be implemented as a host or a device in the system of FIG. 6.

In some examples, the first processor 770 and the second processor 780 are homogeneous. In some examples, first processor 770 and the second processor 780 are heterogenous. Though the example system 700 is shown to have two processors, the system may have three or more processors, or may be a single processor system. In some examples, the computing system is implemented, wholly or partially, with a system on a chip (SoC) or a multi-chip (or multi-chiplet) module, in the same or in different package combinations.

Processors 770 and 780 are shown including integrated memory controller (IMC) circuitry 772 and 782, respectively. Processor 770 also includes interface circuits 776 and 778, along with core sets. Similarly, second processor 780 includes interface circuits 786 and 788, along with a core set as well. A core set generally refers to one or more compute cores that may or may not be grouped into different clusters, hierarchal groups, or groups of common core types. Cores may be configured differently for performing different functions and/or instructions at different performance and/or power levels. The processors may also include other blocks such as memory and other processing unit engines.

Processors 770, 780 may exchange information via the interface 750 using interface circuits 778, 788. IMCs 772 and 782 couple the processors 770, 780 to respective memories, namely a memory 732 and a memory 734, which may be portions of main memory locally attached to the respective processors.

Processors 770, 780 may each exchange information with a network interface (NW I/F) 790 via individual interfaces 752, 754 using interface circuits 776, 794, 786, 798. The network interface 790 (e.g., one or more of an interconnect, bus, and/or fabric, and in some examples is a chipset) may optionally exchange information with a coprocessor 738 via an interface circuit 792. In some examples, the coprocessor 738 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 770, 780 or outside of both processors, yet connected with the processors via an interface such as P-P interconnect, such that either or both processors' local cache information may be stored in the shared cache if a processor is placed into a low power mode.

Network interface 790 may be coupled to a first interface 716 via interface circuit 796. In some examples, first interface 716 may be an interface such as a Peripheral Component Interconnect (PCI) interconnect, a PCI Express interconnect, or another I/O interconnect. In some examples, first interface 716 is coupled to a power control unit (PCU) 717, which may include circuitry, software, and/or firmware to perform power management operations with regard to the processors 770, 780 and/or co-processor 738. PCU 717 provides control information to one or more voltage regulators (not shown) to cause the voltage regulator(s) to generate the appropriate regulated voltage(s). PCU 717 also provides control information to control the operating voltage generated. In various examples, PCU 717 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 717 is illustrated as being present as logic separate from the processor 770 and/or processor 780. In other cases, PCU 717 may execute on a given one or more of cores (not shown) of processor 770 or 780. In some cases, PCU 717 may be implemented as a microcontroller (dedicated or general-purpose) or other control logic configured to execute its own dedicated power management code, sometimes referred to as P-code. In yet other examples, power management operations to be performed by PCU 717 may be implemented externally to a processor, such as by way of a separate power management integrated circuit (PMIC) or another component external to the processor. In yet other examples, power management operations to be performed by PCU 717 may be implemented within BIOS or other system software. Along these lines, power management may be performed in concert with other power control units implemented autonomously or semi-autonomously, e.g., as controllers or executing software in cores, clusters, IP blocks and/or in other parts of the overall system.

Various I/O devices 714 may be coupled to first interface 716, along with a bus bridge 718 which couples first interface 716 to a second interface 720. In some examples, one or more additional processor(s) 715, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 716. In some examples, second interface 720 may be a low pin count (LPC) interface. Various devices may be coupled to second interface 720 including, for example, a keyboard and/or mouse 722, communication devices 727 and storage circuitry 728. Storage circuitry 728 may be one or more non-transitory machine-readable storage media as described below, such as a disk drive or other mass storage device which may include instructions/code and data 730 and may implement the storage in some examples. Further, an audio I/O 724 may be coupled to second interface 720. Note that other architectures than the point-to-point architecture described above are possible. For example, instead of the point-to-point architecture, a system such as multiprocessor system 700 may implement a multi-drop interface or other such architecture.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

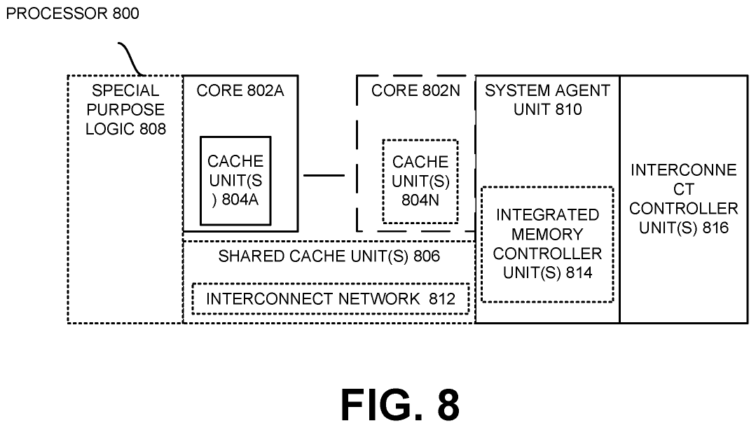

FIG. 8 illustrates a block diagram of an example processor and/or SoC 800 that may have one or more cores and an integrated memory controller. The solid lined boxes illustrate a processor 800 with a single core 802(A), system agent unit circuitry 810, and a set of one or more interface controller unit(s) circuitry 816, while the optional addition of the dashed lined boxes illustrates an alternative processor 800 with multiple cores 802(A)-(N), a set of one or more integrated memory controller unit(s) circuitry 814 in the system agent unit circuitry 810, and special purpose logic 808, as well as a set of one or more interface controller units circuitry 816. Note that the processor 800 may be one of the processors 770 or 780, or co-processor 738 or 715 of FIG. 7.

Thus, different implementations of the processor 800 may include: 1) a CPU with the special purpose logic 808 being integrated graphics and/or scientific (throughput) logic (which may include one or more cores, not shown), and the cores 802(A)-(N) being one or more general purpose cores (e.g., general purpose in-order cores, general purpose out-of-order cores, or a combination of the two); 2) a coprocessor with the cores 802(A)-(N) being a large number of special purpose cores intended primarily for graphics and/or scientific (throughput); and 3) a coprocessor with the cores 802(A)-(N) being a large number of general purpose in-order cores. Thus, the processor 800 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 800 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 804(A)-(N) within the cores 802(A)-(N), a set of one or more shared cache unit(s) circuitry 806, and external memory (not shown) coupled to the set of integrated memory controller unit(s) circuitry 814. The set of one or more shared cache unit(s) circuitry 806 may include one or more mid-level caches, such as level 2 (L2), level 3 (L3), level 4 (L4), or other levels of cache, such as a last level cache (LLC), and/or combinations thereof. While in some examples interface network circuitry 812 (e.g., a ring interconnect) interfaces the special purpose logic 808 (e.g., integrated graphics logic), the set of shared cache unit(s) circuitry 806, and the system agent unit circuitry 810, alternative examples use any number of well-known techniques for interfacing such units. In some examples, coherency is maintained between one or more of the shared cache unit(s) circuitry 806 and cores 802(A)-(N). In some examples, interface controller units circuitry 816 couple the cores 802 to one or more other devices 818 such as one or more I/O devices, storage, one or more communication devices (e.g., wireless networking, wired networking, etc.), etc.

In some examples, one or more of the cores 802(A)-(N) are capable of multi-threading. The system agent unit circuitry 810 includes those components coordinating and operating cores 802(A)-(N). The system agent unit circuitry 810 may include, for example, power control unit (PCU) circuitry and/or display unit circuitry (not shown). The PCU may be or may include logic and components needed for regulating the power state of the cores 802(A)-(N) and/or the special purpose logic 808 (e.g., integrated graphics logic). The display unit circuitry is for driving one or more externally connected displays.

The cores 802(A)-(N) may be homogenous in terms of instruction set architecture (ISA). Alternatively, the cores 802(A)-(N) may be heterogeneous in terms of ISA; that is, a subset of the cores 802(A)-(N) may be capable of executing an ISA, while other cores may be capable of executing only a subset of that ISA or another ISA.

Illustrative examples of the technologies disclosed herein are provided below. An embodiment of the technologies may include any one or more, and any compatible combination of, the examples described below.

Example 1 is a processing apparatus that includes a write-lockable always on (AON) read writeable memory (RWM) and a control circuit. The control circuit is to be coupled with the RWM and with a system management non volatile memory (SMNVM) having boot code and low-power state exit code. The control circuit is to crypto verify the boot code in response to a boot event, cause the verified boot code to be executed if authentic, crypto verify the low-power state exit code, and store the verified low-power state exit code, if authentic, in the write lockable RWM.

Example 2 includes the subject matter of example 1, and wherein the control circuit is part of a boot block.

Example 3 includes the subject matter of any of examples 1 and 2, and wherein the control circuit is part of a root-of trust hardware (HW).

Example 4 includes the subject matter of any of examples 1-3, and wherein the control circuit is to crypto verify the boot code in a crypto engine circuit that is part of a root-of-trust hardware (HW).

Example 5 includes the subject matter of any of examples 1-4, and wherein the control circuit is to crypto verify the low-power state exit code in the crypto engine circuit.

Example 6 includes the subject matter of any of examples 1-5, and wherein the control circuit is to retrieve the low-power state exit code in response to an exit event and cause it to be executed without being crypto verified to restore a chain of trust execution framework in coming out of the low-power state.

Example 7 includes the subject matter of any of examples 1-6, and wherein during the low-power state, the control circuit is power gated.

Example 8 includes the subject matter of any of examples 1-7, and further comprises an always on (AON) finite state machine (FSM) to initiate exiting from the low-power state, wherein the AON FSM causes the control circuit to be activated in response to the exit event.

Example 9 includes the subject matter of any of examples 1-8, and wherein the low-power state is a standby state.

Example 10 includes the subject matter of any of examples 1-9, and wherein the control circuit and write lockable AON RWM are part of a discrete graphics processing Unit (DGPU).

Example 11 is a computing system having a host and at least one DGPU in accordance with the DGPU of example 10.

Example 12 includes the subject matter of any of examples 1-11, and wherein the control circuit and write lockable AON RWM are part of an accelerator device that is part of a computing system having a host processing system.

Example 13 includes the subject matter of any of examples 1-12, and wherein the control circuit is implemented with a micron-controller circuit.

Example 14 includes the subject matter of any of examples 1-13, and wherein the control circuit is to generate a hash signature for the low-power state exit code after verifying it.

Example 15 is an apparatus that includes root-of trust (ROT) HW first and second sections. The first section is to be power-gated during a low-power state and includes a control circuit and a crypto authentication circuit. The second ROT section is to remain powered on during the low-power state and includes an always on (AON) read writeable memory (RWM) that is write lockable, wherein the control circuit is to crypto verify low-power state exit code using the crypto authentication circuit in response to a cold reset event and store the verified low-power state exit code, if authentic, in the write lockable AON RWM.

Example 16 includes the subject matter of example 15, and wherein the low-power state exit code is stored in a system management non volatile memory (SMNVM) prior to being crypto verified by the control circuit.

Example 17 includes the subject matter of any of examples 15-16, and wherein the low-power state is a standby state.

Example 18 includes the subject matter of any of examples 15-17, and wherein the first and second ROT HW sections are part of a boot block.

Example 19 includes the subject matter of any of examples 15-18, and wherein the control circuit is to retrieve the low-power state exit code in response to an exit event and cause it to be executed without being crypto verified to restore a chain of trust execution framework in coming out of the low-power state.

Example 20 includes the subject matter of any of examples 15-19, and wherein the RoT second section comprises an always on (AON) finite state machine (FSM) to initiate exiting from the low-power state, wherein the AON FSM causes the control circuit to be activated in response to the exit event.

Example 21 includes the subject matter of any of examples 15-20, and wherein the RoT HW first and second sections are part of a discrete graphics processing Unit (DGPU).

Example 22 is a computing system having a host and at least one DGPU in accordance with the DGPU of example 21.

Example 22 is a method. The method includes crypto verifying boot code in response to a boot event in a processor. It causes the verified boot code to be executed in a boot block. It crypto verifies low-power state exit code, and stores the verified low-power state exit code in a write lockable RWM.

Example 24 includes the subject matter of example 23, and further comprises in response to a low-power state entry event, at least partially powering down the boot block including powering down a root-of-trust (RoT) HW control circuit.

Example 25 includes the subject matter of any of examples 23-24, and further comprises executing the verified low-power state exit code from the write lockable AON RWM without crypto verifying it.

Example 26 includes the subject matter of any of examples 23-25, and, comprising authenticating the low-power state exit code using a hash signature prior to executing it.

Example 27 includes the subject matter of any of examples 23-26, and wherein the write-lockable AON RWM is unlocked in response to the boot event and locked thereafter until a next boot event.

Example 28 includes the subject matter of any of examples 23-27, and wherein crypto verifying includes crypto verifying using an asymmetric cryptographical method with public and private keys.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included.

Throughout the specification, and in the claims, the term “connected” means a direct connection, such as electrical, mechanical, or magnetic connection between the things that are connected, without any intermediary devices.

The term “coupled” means a direct or indirect connection, such as a direct electrical, mechanical, or magnetic connection between the things that are connected or an indirect connection, through one or more passive or active intermediary devices.

The term “circuit” or “module” may refer to one or more passive and/or active components that are arranged to cooperate with one another to provide a desired function. It should be appreciated that different circuits or modules may consist of separate components, they may include both distinct and shared components, or they may consist of the same components. For example, A controller circuit may be a first circuit for performing a first function, and at the same time, it may be a second controller circuit for performing a second function, related or not related to the first function.

The meaning of “in” includes “in” and “on” unless expressly distinguished for a specific description.

The terms “substantially,” “close,” “approximately,” “near,” and “about,” unless otherwise indicated, generally refer to being within +/−10% of a target value.

Unless otherwise specified, the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner

For the purposes of the present disclosure, phrases “A and/or B” and “A or B” mean (A), (B), or (A and B). For the purposes of the present disclosure, the phrase “A, B, and/or C” means (A), (B), (C), (A and B), (A and C), (B and C), or (A, B and C).

It is pointed out that those elements of the figures having the same reference numbers (or names) as the elements of any other figure can operate or function in any manner similar to that described but are not limited to such.

For purposes of the embodiments, unless expressly described differently, the transistors in various circuits and logic blocks described herein may be implemented with any suitable transistor type such as field effect transistors (FETs) or bipolar type transistors. FET transistor types may include but are not limited to metal oxide semiconductor (MOS) type FETs such as tri-gate, FinFET, and gate all around (GAA) FET transistors, as well as tunneling FET (TFET) transistors, ferroelectric FET (FeFET) transistors, or other transistor device types such as carbon nanotubes or spintronic devices.

In addition, well-known power/ground connections to integrated circuit (IC) chips and other components may or may not be shown within the presented figures, for simplicity of illustration and discussion, and so as not to obscure the disclosure. Further, arrangements may be shown in block diagram form in order to avoid obscuring the disclosure, and also in view of the fact that specifics with respect to implementation of such block diagram arrangements are dependent upon the platform within which the present disclosure is to be implemented.

As defined herein, the term “computer readable storage medium” means a storage medium that contains or stores program code for use by or in connection with an instruction execution system, apparatus, or device. As defined herein, a “computer readable storage medium” is not a transitory, propagating signal per se. A computer readable storage medium may be, but is not limited to, an electronic storage device, a magnetic storage device, an optical storage device, an electromagnetic storage device, a semiconductor storage device, or any suitable combination of the foregoing. Memory elements, as described herein, are examples of a computer readable storage medium.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context. As defined herein, the term “responsive to” means responding or reacting readily to an action or event. Thus, if a second action is performed “responsive to” a first action, there is a causal relationship between an occurrence of the first action and an occurrence of the second action. The term “responsive to” indicates the causal relationship.

As defined herein, the term “processor” means at least one hardware circuit configured to carry out instructions contained in program code. The hardware circuit may be implemented with one or more integrated circuits. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, a graphics processing unit (GPU), a controller, and so forth. It should be appreciated that a logical processor, on the other hand, is a processing abstraction associated with a core, for example when one or more SMT cores are being used such that multiple logical processors may be associated with a given core, for example, in the context of core thread assignment.

It should be appreciated that the processor system 100 may be implemented in various different manners. For example, it may be implemented on a single die, multiple dies (dielets, chiplets), one or more dies in a common package, or one or more dies in multiple packages. Along these lines, some of these blocks may be located separately on different dies or together on two or more different dies.

While the flow diagrams in the figures show a particular order of operations performed by certain embodiments of the invention, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A processing apparatus, comprising:
a write lockable read write memory (RWM); and
a control circuit to be coupled with the RWM and with a system management non volatile memory (SMNVM) having boot code and low-power state exit code, the control circuit to:
in response to a boot event, cryptographically verify the boot code is authentic,
cause the boot code to be executed if authentic,
cryptographically verify the low-power state exit code, and
store the verified low-power state exit code, if authentic, in the write lockable RWM.

2. The apparatus of claim 1, wherein the control circuit is part of a boot block.

3. The apparatus of claim 2, wherein the control circuit is part of a root-of-trust hardware (HW).

4. The apparatus of claim 1, wherein the control circuit is to retrieve the low-power state exit code in response to an exit event and cause it to be executed without being crypto verified to restore a chain of trust execution framework in coming out of the low-power state.

5. The apparatus of claim 4, wherein during the low-power state, the control circuit is power gated.

6. The apparatus of claim 5, comprising an always on (AON) finite state machine (FSM) to initiate exiting from the low-power state, wherein the AON FSM causes the control circuit to be activated in response to the exit event.

7. The apparatus of claim 1, wherein the low-power state is a standby state.

8. The apparatus of claim 1, wherein the control circuit and write lockable AON RWM are part of a discrete graphics processing Unit (DGPU).

9. A computing system having a host and at least one DGPU in accordance with the DGPU of claim 8.

10. The apparatus of claim 1, wherein the control circuit and write lockable AON RWM are part of an accelerator device that is part of a computing system having a host processing system.

11. The apparatus of claim 1, wherein the control circuit is implemented with a micro-controller circuit.

12. The apparatus of claim 1, wherein the control circuit is to generate a hash signature for the low-power state exit code after verifying it.

13. An apparatus, comprising:
a root-of-trust (RoT) hardware (HW) first section that is to be power-gated during a low-power state, the RoT HW first section including a control circuit and a crypto authentication circuit; and
a RoT HW second section that is to remain powered on during the low-power state, the ROT second section including an always on (AON) read writeable memory (RWM) that is write lockable, wherein the control circuit is to crypto verify low-power state exit code using the crypto authentication circuit in response to a cold reset event and store the verified low-power state exit code, if authentic, in the write lockable AON RWM.

14. The apparatus of claim 13, wherein the low-power state exit code is stored in a system management non volatile memory (SMNVM) prior to being crypto verified by the control circuit.

15. The apparatus of claim 13, wherein the low-power state is a standby state.

16. The apparatus of claim 13, wherein the first and second ROT HW sections are part of a boot block.

17. The apparatus of claim 13, wherein the control circuit is to retrieve the low-power state exit code in response to an exit event and cause it to be executed without being crypto verified to restore a chain of trust execution framework in coming out of the low-power state.

18. A method, comprising:
in response to a boot event in a processor, crypto verifying boot code;
causing the verified boot code to be executed in a boot block;
crypto verifying low-power state exit code; and
storing the verified low-power state exit code in a write lockable RWM.

19. The method of claim 18, comprising: in response to a low-power state entry event, at least partially powering down the boot block including powering down a root-of-trust (RoT) HW control circuit.

20. The method of claim 19, comprising executing the verified low-power state exit code from the write lockable RWM without crypto verifying it.
